(19) United States
(12) Patent Application Publication
(10) Pub. No.: US 2025/0193030 A1
(43) Pub. Date: Jun. 12, 2025

(54) METHOD AND SYSTEM FOR PROVING INTEGRITY OF BLOCKCHAIN DATA BASED ON ANCHORING TECHNOLOGY

(71) Applicant: LEADPOINT SYSTEM INC., Jeonju (KR)

(72) Inventors: Eun Ju BAEK, Namyangju (KR); Do Hyoung Kim, Namyangju (KR)

(21) Appl. No.: 18/971,366

(22) Filed: Dec. 6, 2024

(30) Foreign Application Priority Data
Dec. 11, 2023 (KR) 10-2023-0178269

(51) Int. Cl. H04L 9/00; H04L 9/32

(52) U.S. Cl. CPC H04L 9/50; H04L 9/3218

(57) ABSTRACT

Proposed are a method and a system for proving the integrity of blockchain data by using anchoring technology that includes data recorded in a blockchain into another blockchain. The method includes providing external data for electronic notarization, generating and distributing a block, where the external data is recorded, by a blockchain network and an audit network respectively, determining that the ledger information is forged on the basis of a plurality of ledger information after clustering the plurality of ledger information from a plurality of node devices in the blockchain network, providing audit ledger information, whose integrity is proven, to the blockchain network as a first ledger information by the audit network in the response to the determination, and generating and distributing a block, where the first ledger information is recorded, on the basis of the first ledger information by the blockchain network.

### CROSS REFERENCE TO RELATED APPLICATION

The present application claims priority to Korean Patent Application No. 10-2023-0178269, filed on Dec. 11, 2023, the entire contents of which are incorporated herein for all purposes by this reference.

### BACKGROUND OF THE INVENTION

### Field of the Invention

The present disclosure relates to a method and a system for proving the integrity of a blockchain network. More particularly, the present disclosure relates to a method and a system for proving the integrity of blockchain data by using anchoring technology that includes data recorded in a blockchain into another blockchain.

### Description of the Related Art

A blockchain, which is one type of distributed database, uses a peer-to-peer (P2P) network. A distributed database is a technology that makes many users share a large-scale database by physically distributing data. A blockchain is a structure list and network participant node devices can store data and collectively record and manage master data recording transaction information through verification.

When a new block is created in a blockchain network, the block verified through a consensus algorithm of a plurality of participants (node devices) can be connected to the existing block, and be stored in a distributed manner after being confirmed as the final ledger including transaction history. In addition, when a transaction occurs on a participation node information verified through the device, transaction effectiveness verification with respect to the corresponding transaction is transmitted to each node device. Through this, transaction history, that is, verified transactions, are transmitted to be stored in a distributed manner and it is possible to identify the forgery on the basis of the distributedly stored transactions when data of some nodes is forged. The security stability of blockchain increases as more users share data. In addition to virtual currencies such as Bitcoin, blockchain is being utilized in various online services such as cloud computing services.

Meanwhile, attempts to more clearly prove the integrity of notarization documents are being made by applying blockchain technology to electronic notarization systems. For example, when storing the original or a hash value of notarization documents on the blockchain, it is safer from hacking than existing computer systems, thereby adding the reliability to the process of creating, managing, and distributing notarization documents.

### SUMMARY OF THE INVENTION

A technical task to be solved through the exemplary embodiments of the present disclosure is to provide a method and a system for proving the integrity of blockchain data on the basis of anchoring technology capable of proving the integrity when hacking or forgery occurs in a blockchain network, by recording the data recorded in a blockchain network into an audit network, which is another blockchain.

Another technical task to be solved through the exemplary embodiments of the present disclosure is to provide a method and a system, which more reliably ensures the integrity of data stored in a blockchain by checking whether ledger information is forged by using an audit node and which allows blockchain technology to be used for public ledgers that require high data stability and reliability.

Another technical task to be solved through the exemplary embodiments of the present disclosure is to provide a method and a system, which can ensure the integrity of blockchain network data by auditing ledger information in a random consensus proof-based blockchain network through an audit node operating with a plurality of consensus algorithms while allowing a non-random consensus proof-based blockchain network to be utilized as a random consensus proof-based blockchain network.

The technical tasks of the present disclosure are not limited to the technical tasks mentioned above, and other technical tasks not mentioned will be clearly understood by those skilled in the art from the following description.

According to an exemplary embodiment of the present disclosure for solving the above-mentioned problems, a method is for proving an integrity of blockchain data, the method comprising: providing external data for electronic notarization, generating and distributing a block, where the external data is recorded, by a blockchain network and an audit network respectively, determining that the ledger information is forged on the basis of a plurality of ledger information after clustering the plurality of ledger information from a plurality of node devices in the blockchain network, providing audit ledger information, whose integrity is proven, to the blockchain network as a first ledger information by the audit network in the response to the determination, and generating and distributing a block, where the first ledger information is recorded, on the basis of the first ledger information by the blockchain network, wherein the blockchain network generates the block to be distributed in the blockchain network through a neural consensus proof-based block generation process.

According to another exemplary embodiment of the present disclosure for solving the above-mentioned problems, a system is provided for proving an integrity of blockchain data, the system comprises a blockchain network for electronic notarization including a plurality of node devices performing a block generation process based on neural consensus proof according to a preset condition, and an audit network replying with audit ledger information, whose integrity is proven, as first ledger information to the blockchain network, in response to determining that ledger information of the plurality of node devices are forged, wherein the blockchain network and the audit network respectively generate and distribute a block where the external data is recorded, when external data for electronic notarization is provided, the blockchain network generates a block to be distributed in the blockchain network through a block generation process based on neural consensus proof, and the neural consensus proof-based block generation process comprises: extracting an effective verification data from a new block data, obtaining neural consensus designation information of a next block generated on the basis of a random consensus proof process according to a verification processing of the effective verification data, selectively operating a consensus node function unit on the basis of the neural consensus designation information of the next block, and generating the effectiveness verification data of the next block.

According to the exemplary embodiments of the present disclosure described above, it is possible to easily prove or restore the integrity when hacking or forgery occurs in the blockchain network through anchoring technology that records the data of the blockchain network equally in the audit network.

In addition, it is possible to check the forgery and restore the integrity even for blockchains where a 51% attack is successful, by checking the forgery of ledger information using an audit node, such that the integrity of data stored in the blockchain can be more surely guaranteed and blockchain technology can be more easily utilized even for public books that require high stability and reliability of data.

In addition, it is possible to provide an efficient and fair neural consensus proof-based distributed consensus process while preventing waste of resources and social costs, by converting to be utilized as a random consensus proof-based blockchain network while maintaining the infrastructure and utility of the pre-established non-random consensus proof-based blockchain network as much as possible.

The beneficial effects of the present disclosure are not limited to the mentioned above, and other beneficial effects not mentioned will be clearly understood by those skilled in the art from the following description.

### BRIEF DESCRIPTION OF THE DRAWINGS

The above and other objectives, features and other advantages of the present disclosure will be more clearly understood from the following detailed description when taken in conjunction with the accompanying drawings.

FIG. 1 is a diagram schematically showing an entire system according to an exemplary embodiment of the present disclosure.

FIG. 2 is a diagram for explaining a blockchain network according to an embodiment of the present disclosure.

FIG. 3 is a block diagram showing in more detail a node device according to an embodiment of the present disclosure.

FIG. 4 is a conceptual diagram for explaining the configuration of a neural consensus proof module cluster according to an embodiment of the present disclosure and the block generation process.

FIG. 5 is a flowchart for explaining a method of operating the node device according to an embodiment of the present disclosure.

FIGS. 6 to 9 are diagrams exemplifying data by step that are processed by a consensus proof module node device according to an embodiment of the present disclosure.

FIG. 10 is a flowchart for explaining a method of operating a node device according to another embodiment of the present disclosure.

FIG. 11 is a flowchart for explaining a method of operating a node device according to another embodiment of the present disclosure.

FIG. 12 is a diagram illustrating a system for proving the integrity of blockchain data on the basis of anchoring technology according to an exemplary embodiment of the present disclosure.

FIG. 13 is a diagram illustrating a system for proving the integrity of blockchain data on the basis of anchoring technology according to another exemplary embodiment of the present disclosure.

FIGS. 14 and 15 are diagrams for explaining a method for proving and restoring the integrity of the blockchain network 1000 by using the audit network 2000.

FIG. 16 is a block diagram showing a detailed configuration of an audit node 300 according to an exemplary embodiment of the present disclosure.

FIG. 17 is a flowchart showing a method for proving the integrity of blockchain data on the basis of anchoring technology according to an exemplary embodiment of the present disclosure.

FIG. 18 is a block diagram illustrating the hardware configuration of a computing device used to implement various embodiments of the present disclosure.

### DETAILED DESCRIPTION OF THE INVENTION

The following provides only the principle of the present disclosure. Accordingly, those skilled in the art may implement the principle of the present disclosure and various apparatuses included in the concept and range of the present disclosure which are not clearly described or shown herein though. All conditional terminologies and embodiments described herein should be understood as being definitely intended as an object for understanding the concept of the present disclosure without limiting the specifically stated embodiments and states.

Further, all detailed descriptions enumerate not only the principle, aspects, and embodiments of the present disclosure, but specific embodiments should be understood as being intended to include structural and functional equivalents of those matters. Further, these equivalents should be understood as including all elements designed to perform the same functions regardless of not only equivalents known at present, but equivalents, that is, structures to be developed in the future.

Accordingly, for example, block diagrams of this specification should be understood as showing an exemplary conceptual respect that concretes the principle of the present disclosure. Similarly, all of flowcharts, state conversion diagrams, intention codes, etc. should be understood as showing various processes that can be substantially shown on computer-readable media and are performed by computers and processors regardless of whether a computer or a processor is definitely shown.

Further, definite use of terms proposed as a processor, control, or similar concepts should not be construed by exclusively citing hardware having ability to execute software and should be construed as suggestively including digital signal processor (DSP) hardware, and a ROM, a RAM, and a nonvolatile memory for storing software without limitation. Other well-known and generally used hardware may also be included.

The objectives, features, and advantages of the present disclosure described above will be clearer through the following detailed description relating to the accompanying drawing, so the spirit of the present disclosure would be easily implemented by those skilled in the art. Further, in description of present the disclosure, well-known technologies are not described in detail not to unnecessarily obscure the subject of the present disclosure.

In the present disclosure, the term “integrity” can be understood to have the same meaning as “originality,” and “integrity” and “originality” may be used interchangeably with the same meaning.

Anchoring may refer to periodically including a hash value of data recorded in a private blockchain into a public blockchain. In general, private blockchains may be more likely to be attacked by hackers than public blockchains, such that the ledger information has a higher possibility of forgery. Accordingly, forgery of data may be prevented by periodically including a hash value of transaction data or block data recorded in a private blockchain into transaction of a public blockchain such as Bitcoin, which is called anchoring technology.

However, in the present disclosure, anchoring may be defined as recording the same transaction data on two or more blockchains without distinguishing between private and public blockchains. That is, even when both blockchains are private blockchains, and one transaction data is recorded simultaneously or sequentially in the two private blockchains, the present disclosure may regard this as using anchoring technology.

Hereinafter, exemplary embodiments of the present disclosure will be described in detail with reference to the accompanying drawings.

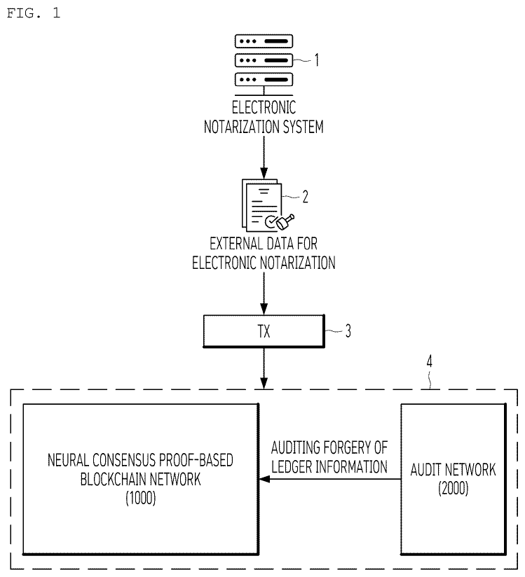

FIG. 1 is a diagram schematically showing an entire system according to an exemplary embodiment of the present disclosure. Referring to FIG. 1, external data 2 for electronic notarization outputted through the electronic notarization system 1 may be carried in a transaction 3 (or transaction data) and stored in a neural consensus proof-based blockchain network 1000 included in a system 4 for auditing forgery of ledger information. The neural consensus proof-based blockchain network 1000 may be composed of a plurality of node devices, and the plurality of node devices may compose a neural consensus proof module cluster, thereby verifying the integrity of the ledger information of each node device through a consensus algorithm.

Accordingly, even when the ledger information of some node devices is damaged for hacking or other reasons, the integrity of the data stored in the blockchain network 1000 can be guaranteed because the same content as the original is immediately restored by the consensus algorithm of the neural consensus proof module cluster.

Although the blockchain network 1000 has a consensus algorithm capable of restoring the originality (or integrity), the damaged original may not be restored by itself in some extreme situations. For example, when a 51% of the attack on the blockchain network 1000 is successful and incorrect ledger information is considered to be the original, it may be difficult for the blockchain network 1000 to restore the damaged original by itself.

To remedy this problem, the system 4 for auditing the forgery of ledger information may audit the forgery of ledger information of node devices in the blockchain network 1000 through the audit network when it is determined that the originality of the blockchain network 1000 is damaged, and may provide the correct ledger information stored in the audit network 2000 to the blockchain network 1000, thereby restoring the originality of the ledger information of each node device in the blockchain network 1000.

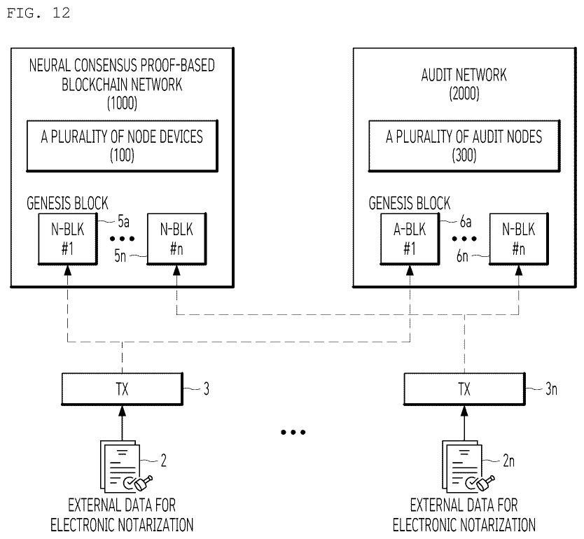

In this case, through anchoring technology that stores transaction data in a blockchain network and an audit network respectively, the integrity of ledger information of each node device in the blockchain network may be proven, and undamaged ledger information may be restored. A method for proving the integrity by using such anchoring technology will be described in detail with reference to FIG. 12.

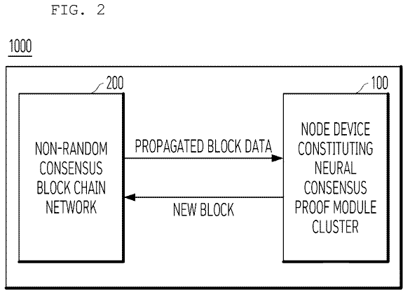

FIG. 2 is a diagram for explaining a blockchain network 1000 according to an embodiment of the present disclosure.

A blockchain network 1000 according to an embodiment of the present disclosure may be a mesh-topology blockchain network configured by one or more node devices connected through a wired or wireless network. The node devices are connected to the blockchain network through I/O devices and can exchange data. The blockchain network system 1000 may include, as the node devices, various electronic systems such as mobile devices including a mobile phone, a smartphone, a PDA, a tablet computer, a laptop, etc., computing devices including a personal computer, a tablet computer, a netbook, etc., or electronic products including a television, a smart television, a security device for gate control, etc.

Further, each of the node devices 100 may have a communication module for connecting to the blockchain network. The blockchain network, for example, may be implemented as a wired network such as a Local Area Network (LAN), a Wide Area Network (WAN), or a Value Added Network (VAN). Further, the blockchain network may be implemented as all kinds of wireless networks such as a mobile radio communication network, a satellite communication network, Bluetooth, Wireless Broadband Internet (Wibro), High Speed Downlink Packet Access (HSDPA), Wi-Fi, Long Term Evolution (LTE). Depending on necessity, the blockchain network may be a wired-wireless mixed network.

Further, each of the node devices can register account information according to its node connection in transaction ledger data that are shared in a cloud manner through a network. Further, when there is a need for a transaction of encryption information for creating a blockchain, each trader terminal can propagate transaction information to be recorded in the transaction ledger data to every trader terminal.

Further, the transaction ledger data are updated and the information thereof is shared in accordance with mutual verification processing corresponding to the above process, whereby a transaction of encryption information for creating a blockchain can be made.

In this case, the transaction ledger data can be linked with a blockchain data having a structure in which a plurality of blocks is sequentially connected in order of creation by making each of blocks corresponding to predetermined times or units include a hash value for a block created before a current block. Accordingly, it is possible to easily verify whether the transaction ledger data have been tampered by verifying the hash values of the blockchain.

Security stability of the blockchain can be implemented by participation in the system of sharers who share data. Accordingly, transaction information blocks, which include specifications of sharing between sharer terminals connected to the blockchain network, specifications of issuance/transaction of encryption information for creating the blockchain, etc., can be sequentially stored, and transaction verification processing for sequentially making hash values for anti-tempering thereof into a blockchain can be distributionally performed at the trader terminals.

A non-random consensus blockchain network 200 may refer to a non-random proof-based blockchain network, such as a Proof-of-Work (PoW) or Proof-of-Stake (PoS) blockchain network. For example, the non-random consensus blockchain network 200 may be the Bitcoin or Ethereum network.

The node devices 100 according to an embodiment of the present disclosure can constitute a neural consensus proof module cluster, and the neural consensus proof module cluster can configure a new block combined with neural consensus validation data on the basis of random consensus proof manner and can process the configured new block to be propagated through the non-random consensus blockchain network 200.

Accordingly, in the non-random consensus blockchain network 200, the propagated block data are shared again in the network and can be processed such that a next block is created again by the node device 100 configuring the neural consensus proof module cluster. Since specific proof such as PoW and PoW is not required in this process, it is possible to construct a new random consensus blockchain network system 1000 that can implement decentralization in a non-competitive manner.

That is, according to an embodiment of the present disclosure, since the neural consensus proof module cluster that enables the existing non-random consensus proof-based blockchain network 200 to be used as the random consensus proof-based blockchain network 1000 is constructed using the node device 100, it is possible to provide the node device 100 forming a network that enables a random consensus proof-based blockchain network based on a pre-constructed blockchain network to be operated while controlling an existing pre-constructed PoW-type or PoS-type blockchain network not to be operated anymore in the PoW or PoS manner or to be limitatively operated in accordance with the minimum number of nodes of a Byzantine fault tolerance consensus.

Accordingly, it is possible to convert the pre-constructed non-random consensus proof-based blockchain network to be used as a random consensus proof-based blockchain network while maximally maintaining the infrastructure and usefulness of the pre-constructed non-random consensus proof-based blockchain network, so it is possible to provide a neural consensus proof-based distributed consensus process that prevents a waste of resources and social costs and is efficient and fair. In this case, a nonce chain and hash checking process configured on the basis of one-time random numbers may be used for participation qualification proof for a random consensus, but this is only an example designation and participation qualification proof of a random consensus can be possible even in various other manners.

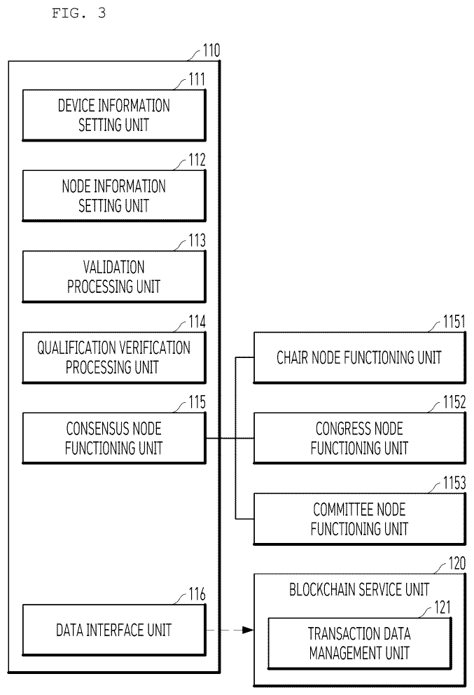

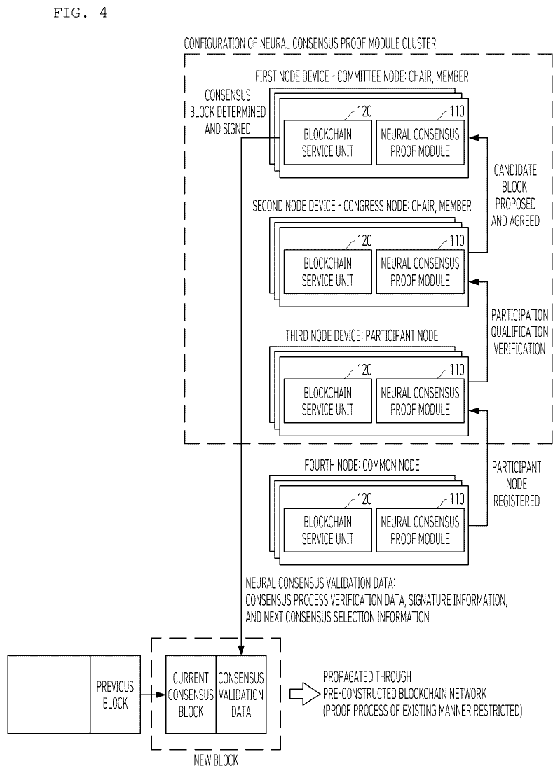

FIG. 3 is a block diagram showing in more detail a node device 100 according to an embodiment of the present disclosure and FIG. 4 is a conceptual diagram for explaining the configuration of a neural consensus proof module cluster according to an embodiment of the present disclosure and the entire process.

The node devices 100 of the blockchain system 1000 according to the present disclosure may be included in a neural consensus proof module cluster for configuring a next block through a random node selection process and each may include a neural consensus proof module 110 included in the neural consensus proof module cluster to perform a random consensus proof process according to an embodiment of the present disclosure.

Further, the node devices 100 are connected to the non-random consensus blockchain network 200 and each may include a blockchain service unit 120 performing a sharing-propagating process of a next block configured by the random consensus proof process through the non-random consensus blockchain network 200.

Accordingly, in an embodiment of the present disclosure, the node devices 100 may be node devices 100 that participate in the non-random consensus blockchain network 200, and are selected by the random consensus selection process and selectively granted with a right to be able to create respective blocks in accordance with consensus conference, and accordingly, the random consensus blockchain network system 1000 can be independently constructed.

Further, as shown in FIG. 4, the node devices 100 can selectively perform the functions of a fourth node device that is a common node, a third node device that is a participant node, a second node device that is a congress node, and a first node that is a committee node.

The neural consensus proof module cluster may be constructed with the third node device registered as a participant node for a basis. The participant node that is the third node device can verify a participation qualification on the basis of next consensus selection information that is obtained from consensus validation data of a new propagated block and the second node device may be a terminal that processes a congress node function operation by ascertaining whether a congress node is selected in accordance with the verification result. The first node device may be a terminal that processes a committee node function operation by ascertaining whether a committee node is selected in accordance with the verification result.

A node device 100 selected as a congress node can perform a candidate block proposal and consensus process like the second node device shown in FIG. 4, and a node device 100 selected as a committee node can perform a process of configuring and distributing consensus validation data of a next block by determining a consensus block and collecting signature information. In this case, the consensus validation data may include conference process verification data, multiple signature information, and next consensus selection information, and can be propagated through a pre-constructed non-random consensus blockchain network 200.

As a new block is configured and propagated in this way, the proof process of the existing non-random consensus blockchain network 200 can be processed to be restricted and Pow or Pos proof-based next block creation between node devices 100 can be processed only in an exceptional case in which the number of some nodes lacks a number set on the basis of a PBFT standard.

Meanwhile, such a participation qualification and verification information of the nodes 100 can be calculated on the basis of a random value, which is calculated for each node in accordance with participant node registration, and can be mutually opened and verified, in which a nonce chain can be used, as described above. For example, the node devices 100 can be determined as at least one of a participant node, a congress node, a committee node, or a chair node, depending on what value a self qualification verification value accompanying hash processing, which uses a nonce value included in next consensus selection information, a height value of a current block, etc., is.

Further, as shown in FIG. 3, a node device 100 according to an embodiment of the present disclosure includes a device information setting unit 111, a node information setting unit 112, an validation processing unit 113, a qualification verification processing unit 114, a consensus node functioning unit 115, and a data interface unit 116.

The device information setting unit 111 obtains, stores, and manages device information of a terminal 100 in which the neural consensus proof module 110 is installed. In this case, the device information may include at least one of node name information, device address information, device performance information, device reliability information, a used network information of the terminal 100. The device information can be used to recognize or construct a neural consensus proof module cluster, perform a vote consensus process, etc.

The node information setting unit 112 sets node information for registering a non-random consensus blockchain network 200 and a participant node. The set node information may include blockchain network client address information and the terminal 100 can connect to the blockchain network using the blockchain network client address information and can obtain or share block information.

The validation processing unit 113 obtains new block data propagated through the non-random consensus blockchain network 200, extracts validation data from the new block data, and obtains neural consensus designation information of a next block created on the basis a random consensus proof process in accordance with verification processing of the validation data.

Further, the consensus node functioning unit 115 is selectively driven on the basis of the neural consensus designation information of a next block and creates validation data of the next block, and can selectively drive at least one of a chair node functioning unit 1151, a congress node functioning unit 1152, and a committee node functioning unit 1153. The chair node functioning unit 1151 may be selectively operated through at least partial comparison of neural consensus designation information and the nonce value of a designated node device 100, but the present disclosure is not limited to this selection manner.

First, the chair node functioning unit 1151 can perform a chair process corresponding to congress and committee nodes and can collect, from congress nodes, delegation information and participation qualification verification information of an effective transaction block taken from a transaction pool of a blockchain network, and next block consensus candidate information. Accordingly, 3f+1 (f is a natural number) or more congress nodes for the next block can be selected and 2f+1 or more committee nodes can be selected.

Further, the congress node functioning unit 1152 can transmit delegation information and participation qualification verification information of an effective transaction block taken from a transaction pool of the non-random consensus blockchain network 200 to the node device 100 in which the chair node functioning unit 1151 is driven.

Further, the chair node functioning unit 1151 can select a block coinciding over a consensus quorum of a congress node as a candidate block from transaction blocks proposed by the congress node, can transmit a message requesting partial signature processing for multiple signature regions expressing consensus for the candidate block to node devices 100 in which the committee node functioning unit 1153 was driven. For example, the chair node functioning unit 1151 can determine f+1 coinciding transaction data candidate blocks from 2f+1 transaction data candidate blocks and can transmit a message requesting partial signature processing for multiple signature regions to the committee functioning node 1153, and a node 100 in which the committee node functioning unit 1153 was driven can process and transmit partial signatures expressing consensus corresponding to the candidate blocks to the node device 100 in which the chair node functioning unit 1151 was driven

Accordingly, the chair node functioning unit 1151 verifies and determines a candidate block for which multiple signature processing has been finished in accordance with committee consensus as distribution block, and creates a new block by creating and combining validation data corresponding to the consensus process with the distribution block.

The data interface unit 116 can convert the crated new block into the format of the non-random consensus blockchain network 200 and then transmit the new block to the blockchain service unit 120.

Then, the blockchain service unit 120 can propagate the new block through the non-random consensus blockchain network 200, and the new block not only can be propagated through the non-random consensus blockchain network 200, but can be added to a transaction data memory pool (mem pool) by operation of a transaction data management unit 121.

Meanwhile, though not shown, the node device 100 may include a memory that the blockchain service unit 120 and the neural consensus proof module 110 can use. The memory may include computer-readable instructions, and as the instructions stored in the memory are executed in a processor, the blockchain service unit 120 and the neural consensus proof module 110 can perform the operations described above. The memory may be a volatile memory or a nonvolatile memory.

The memory may include a storage to store data of a user. The storage may be an embedded multimedia card (eMMC), a solid state drive (SSD), a universal flash storage (UFS), etc. The storage may include at least one or more nonvolatile memory device. The nonvolatile memory device may be a NAND Flash Memory, a Vertical NAND (VNAND), a NOR Flash Memory, a Resistive Random Access Memory (RRAM), a Phase-Change Memory (PRM), a Magnetoresistive Random Access Memory (MRAM), a Ferroelectric Random Access Memory (FRAM), a Spin Transfer Torque Random Access Memory (STT-RAM), etc.

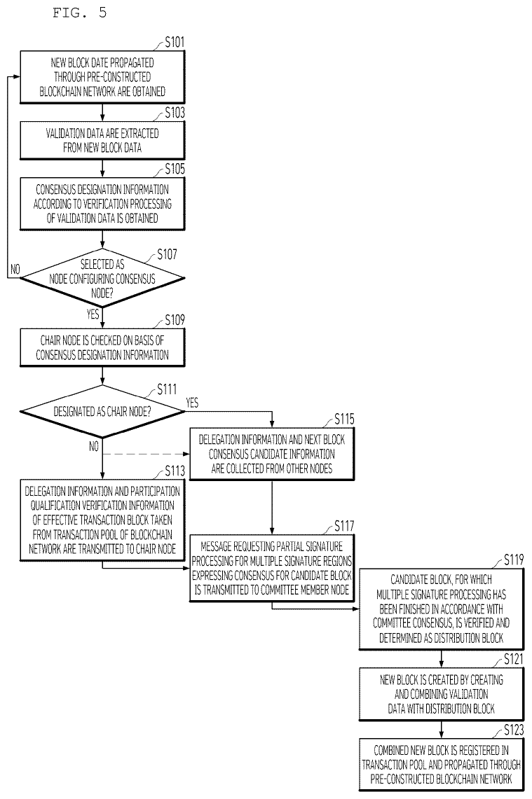

FIG. 5 is a flowchart for explaining a method of operating a node device 100 according to an embodiment of the present disclosure.

Referring to FIG. 5, when a node device 100 according to an embodiment of the present disclosure obtains new block data propagated through a pre-constructed non-random consensus blockchain network 200 (S101), the validation processing unit 113 extracts validation data from the new block data and obtains consensus designation information according to verification processing of the validation data (S103).

The validation processing unit 113 can obtain neural consensus designation information of a next block created on the basis of a random consensus proof process, in accordance with verification processing of the validation data, and as described above, the validation data may include consensus process verification data corresponding to the random consensus proof process.

For example, the consensus process verification data may include nonce chain-based qualification proof hash data and multiple signature data formed by combining partial signatures of the congress node as member qualification verification information of a congress node that processes consensus for transaction data. Further, the neural consensus designation information of a next block may include nonce information for verifying the neural consensus participation qualification corresponding to the next block.

Then, the node device 100 determines whether it has been selected as a node configuring a neural consensus proof cluster node for the next block (S107), and ascertains whether it is a chair node on the basis of consensus designation information when it has been selected (S109).

When the node device has not been selected as a chair node, it can transmit delegation information and participation qualification information of the effective transaction block taken from the transaction pool of the blockchain network in accordance with the qualification to a congress chair node (S113).

Accordingly, a node device 100 in which the chair node functioning unit 1151 was driven can collect delegation information and next block consensus candidate information from other nodes (S115).

Further, the node device 100 in which the chair node functioning unit 1151 was driven determines an agreed candidate block from node devices 110 in which the congress node functioning units 1152 were driven, and transmits a message requesting partial signature processing for multiple signature regions expressing consensus for the candidate block to a committee member node (S117).

Further, the node device 100 in which the chair node functioning unit 1151 was driven verifies and determines a candidate block, for which multiple signature processing has been finished in accordance with the committee consensus, as a distribution block (S119), creates a new block by creating and combining validation data with the distribution block (S121), registers the combined new block into the transaction pool of the non-random consensus blockchain network 200, and propagates the new block through the pre-constructed non-random consensus blockchain network 200 (S123).

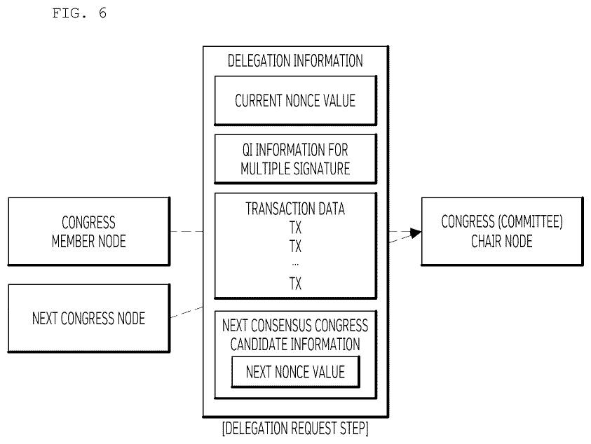

FIGS. 6 to 9 are diagrams exemplifying data of each step that are processed by a consensus proof module node device according to an embodiment of the present disclosure.

FIG. 6 exemplifies delegation information that is transmitted to a chair node in a delegation request step for configuring a current block, in which a nonce value corresponding to a current block height, Qi value information that each congress node intends to use for multiple signatures, transaction data, next consensus congress candidate information, and a nonce value of the next block height may be included in the delegation information.

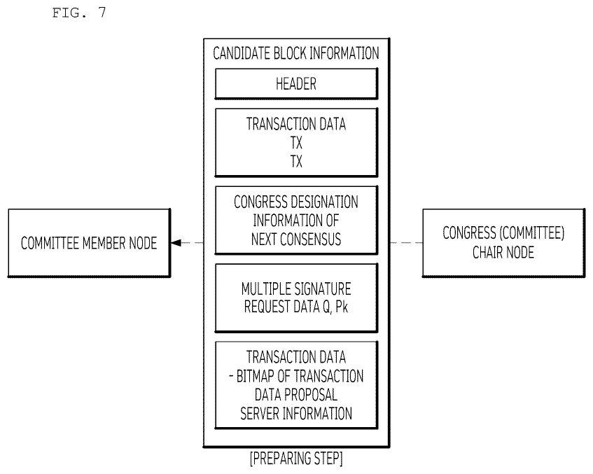

Further, FIG. 7 exemplifies candidate block information that is transmitted to a committee node from a chair node in a preparation step, in which the candidate block information may include header information including a Merkle root, candidate block transaction data, congress designation information of a next consensus, multiple signature request data (Q data integrating Qi, open key Pk), and verification data. Bitmap information that makes it possible to recognize server information proposing transaction data, etc. may be exemplified as the verification data, which makes it possible to prevent a case, etc. proposed by a chair node itself.

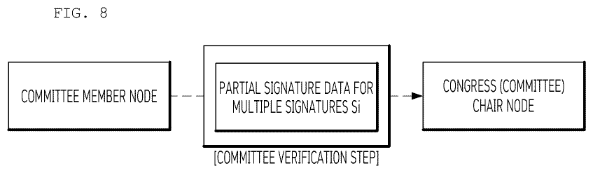

Further, FIG. 8 exemplifies partial signature data that are propagated to a chair node from a committee node in a process in which committee verification is processed, in which the chair node can calculate signature completion data S by integrating partial signature data Si.

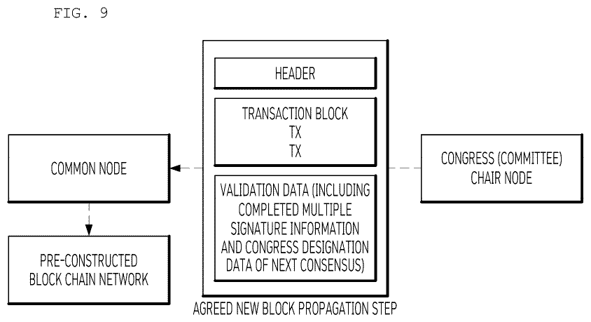

Meanwhile, FIG. 9 shows the configuration of a new block that is created and propagated in accordance with an embodiment of the present disclosure, in which the new block may include header information, transaction block information, and validation data. The validation data, as described above, may include next consensus designation information, completed multiple signature information, and various items of information that can verify a consensus process and a participation qualification. Further, a Merkle root value for validation of block data themselves, etc. may be included also in the header information.

Accordingly, the validation processing unit 113 primarily verifies a consensus process by first ascertaining multiple signature information, can perform secondary verification by ascertaining whether the Merkle root value of a header is normal, and performs third verification by comparing the Merkle root value with a Merkle root value calculated again using transaction block information, thereby enabling safe processing of a transaction block.

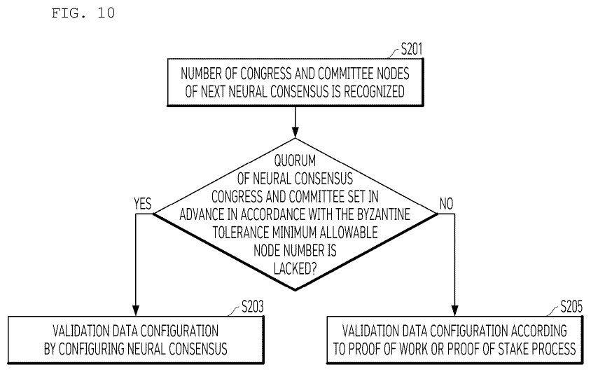

FIG. 10 is a flowchart for explaining a method of operating a node device device according to another embodiment of the present disclosure.

Referring to FIG. 10, a node device 100 according to another embodiment of the present disclosure first recognizes the number of congress and committee nodes of a next neural consensus (S201).

Further, the node device 100 determines whether a preset consensus quorum is not reached on the basis of Byzantine tolerance minimum allowable node number.

For example, a consensus quorum can be determined by a maximum Byzantine number (maximum allowable number of malicious nodes) that can be selected by a node selection probability P in correspondence to the number N of participant nodes, and when congress nodes are at least 3f+1 (f is a natural number) and committee nodes are at least 2f+1 or more, the nodes can satisfy the consensus quorum.

When the number of consensus nodes lacks the quorum of neural consensus congress and committee set in advance in accordance with the Byzantine tolerance minimum allowable node number, the node device 100 performs selective exceptional processing of forming the validation data of a next block in the Proof of Work (PoW) or Proof of stake (Pos) manner (S205).

On the contrary, when the number of consensus nodes is equal to or more than the quorum of neural consensus congress and committee set in advance in accordance with the Byzantine tolerance minimum allowable node number, the Proof of Work (PoW) or Proof of stake (Pos) process of the non-random consensus proof-based blockchain network is restricted, a neural consensus is configured using the process of FIG. 5 described above, and validation data are configured, thereby being able to create and propagate a new block (S203).

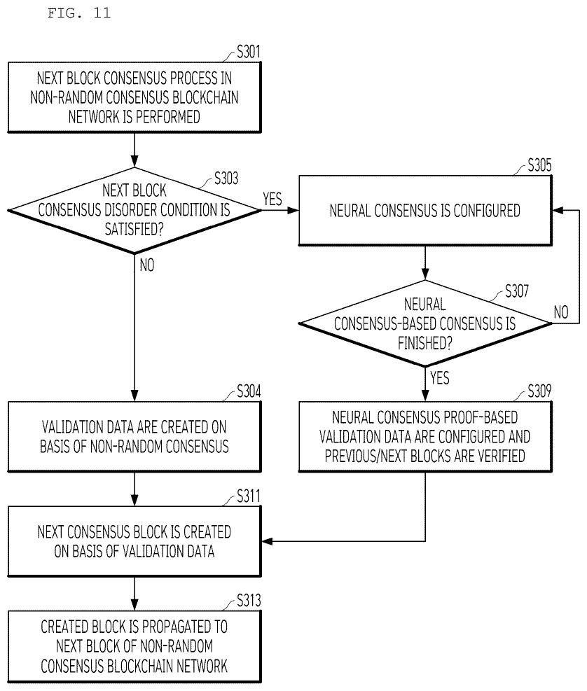

FIG. 11 is a flowchart for explaining a method of operating a node device device according to another embodiment of the present disclosure.

Referring to FIG. 11, performing processes of recognition or construction of a neural consensus proof module cluster and a vote consensus process according to another embodiment of the present disclosure can be used to quickly create a next block to secure continuity when a disorder is generated in a non-random consensus blockchain network 200.

In general, in a non-random consensus manner of proof of work or proof of stake such as Ethereum, there are problems such as timeout of a block creation cycle or unstable consensus by repeated transactions due to abnormal service driving or overload. Accordingly, a service is temporarily stopped or hardfork is performed, so a current non-random consensus blockchain network 200 is not guaranteed with sufficient continuity in block creation and is vulnerable to dealing with disorders.

Accordingly, a process, which performs recognition or construction of a neural consensus proof module cluster and a vote consensus process according to an embodiment of the present disclosure, is complementarily performed when a disorder is generated while the existing non-random consensus blockchain network 200 is driven, so the process can be applied in a manner of securing continuity.

This can be achieved by setting one or more of node devices constituting the existing non-random consensus blockchain network 200 to operate as the node device 100 constituting the neural consensus proof module cluster described above without constructing a specific infrastructure when a preset disorder condition is generated.

In more detail, referring to FIG. 11, the node devices 100 according to an embodiment of the present disclosure may be node devices constituting the non-random consensus blockchain network 200 and may be terminals that operate as node device 100 constituting a neural consensus proof module cluster and configure and propagate neural consensus-based validation data as a next block when a preset next block consensus disorder condition is generated.

For such configuration, the node devices 100 may be driven as devices constituting a preset neural consensus proof module cluster and may be driven in a continuity security mode for securing continuity unlike converting and driving the existing block chain described above.

For example, the node devices 100 can be driven in any one of a network conversion mode in which the node devices 100 convert and use the existing non-random consensus blockchain network 200 as a random consensus blockchain network and a continuity security mode in which the node devices 100 are driven in an assistant manner when a disorder is generated in the existing non-random consensus blockchain network 200, and FIG. 11 shows the operation in the continuity security mode.

First, a node device 100 performs a next block consensus process in a common non-random consensus blockchain network 200 (S301).

Further, the node device 100 determines whether a next block consensus disorder condition is generated (S303).

In this case, various conditions may be set in advance for the next block consensus disorder condition, and preferably, a timeout condition when a block is not created for a first time may be used. For example, the first time may be the same as a second time that is a timeout time prescribed in the process of proof of work or proof of stake of the non-random consensus blockchain network 200.

Further, the first time may be set as a time shorter than the second time in consideration of continuity of work such that configuring a neural consensus proof module cluster is processed earlier than the timeout of the non-random consensus blockchain network 200.

Further, temporal service stop, etc. may be exemplified as the next block consensus disorder condition. For example, when the service of the non-random consensus blockchain network 200 is stopped due to hardfork or temporal service operation problem, assistant block creation processing that accompanies configuring a neural consensus proof module cluster may be set to be continuously performed.

When a disorder condition about the next block consensus is not generated, non-random consensus-based validation data on the non-random consensus blockchain network 200 are created in the manner of common proof of work or proof of stake (S304).

Further, when a disorder condition about the next block consensus is generated, the node device 100 described above can operates as the node device 100 constituting a neural consensus proof module cluster and performs the random-type neural consensus proof module cluster configuration process described with reference to FIGS. 4 and 5 and a consensus process based on the process (S305).

When consensus based on the neural consensus proof module cluster is finished (S307), the node device 100 configures neural consensus proof-based validation data and verifies data effectiveness between a previous block and a next block configured in the non-random consensus blockchain network 200 on the basis of the configured validation data (S309).

In this case, specific height information, previous block information, and next block information can be used for data validation between the previous block and the next block, and a block of non-random consensus format that can be used in the non-random consensus blockchain network 200 can be used through validation on the basis of the information.

Thereafter, the node device 100 creates a next consensus block based on the non-random consensus-based validation data in step S304 or the neural consensus proof-based validation data verified in step S309 (S311).

For example, the node device 100 creates a next block including the neural consensus proof-based validation data, that is, can create a next block of non-random consensus format verified by step S309. In more detail, when a current maximum height is 100, the node device 100 can create a next block that makes consensus be restarted on the non-random consensus blockchain network 200 from a block having a height of 110.

Further, the node device 100 propagates the created block as the next block of the non-random consensus blockchain network 200 (S313).

As such process of the node device 100 is performed, a neural consensus proof-based block creation process, which is driven in an assistant manner when a disorder is generated in the non-random consensus blockchain network 200 of proof of work or proof of stake manner such a Ethereum or Bitcoin, is performed, so continuity of a service can be sufficiently secured.

FIG. 12 is a diagram illustrating a system for proving the integrity of blockchain data on the basis of anchoring technology according to an exemplary embodiment of the present disclosure. Referring to FIG. 12, the blockchain network 1000 may be a blockchain network based on neural consensus proof and may include a plurality of node devices 100, and the audit network 2000 may be a blockchain network based on another consensus algorithm that operates independently from the blockchain network 1000 and may include a plurality of audit nodes 300.

The blockchain network 1000 and the audit network 2000 may independently generate their own blocks by using this as transaction data when external data for electronic notarization is generated.

For example, when the external data 2 for electronic notarization is generated for the first time, the transaction data 3 may be generated on the basis of this, and the blockchain network 1000 may perform a block generation process based on neural consensus proof through the plurality of node devices 100, thereby generating the first neural block (5a), which is a genesis block including transaction data 3. Along with that, the audit network 2000 may perform a block generation process based on its own consensus algorithm through the plurality of audit nodes 300, thereby generating the first audit block (6a), which is another genesis block including the transaction data 3. That is, for one transaction data 3, each of the blockchain network 1000 and the audit network 2000 may generate a block, so that a total of two genesis blocks are generated.

Then, whenever transaction data is additionally generated thereafter and a new block is generated, the blockchain network 1000 and the audit network 2000 may generate a new block subsequent to each genesis block. For example, when the n-th block for the transaction data (3n) is generated, the blockchain network 1000 and the audit network 2000 may respectively generate the n-th neural block (5n) and the n-th audit block (6n) on the basis of the same transaction data (3n).

As an exemplary embodiment, the external data 2 for electronic notarization may include an original electronic notarization document or a hash value extracted from an electronic notarization document.

Meanwhile, in FIG. 12, it may be illustrated that the transaction data (3, 3n) are provided directly to the blockchain network 1000 and the audit network 2000, respectively, but the scope of the present disclosure is not limited thereto.

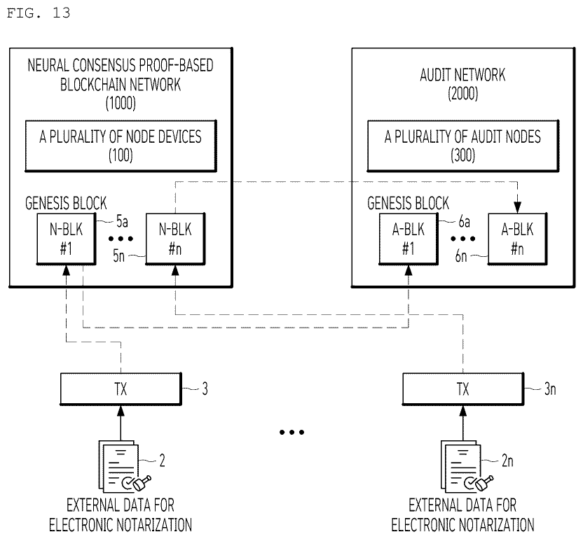

For example, as shown in FIG. 13, the transaction data (3, 3n) may be transmitted only to the blockchain network 1000, and the audit network 2000 may generate audit blocks (6a, 6n) on the basis of the ledger information that the blockchain network 1000 transmits on the basis of that after generating its neural blocks (5a, 5n).

Alternatively, contrary to the example shown in FIG. 13, the transaction data (3, 3n) may be transmitted only to the audit network 2000, and the blockchain network 1000 may generate neural blocks (5a, 5n) on the basis of the ledger information that the audit network 2000 transmits on the basis of that after generating its audit blocks (6a, 6n).

However, these may differ only in the transmission path and order of transaction data 3 that composes block data, and as a result, there may be no difference in that each of the blockchain network 1000 and the audit network 2000 generates blocks including the same ledger information by using its own consensus algorithms.

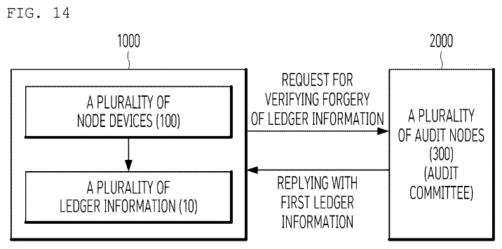

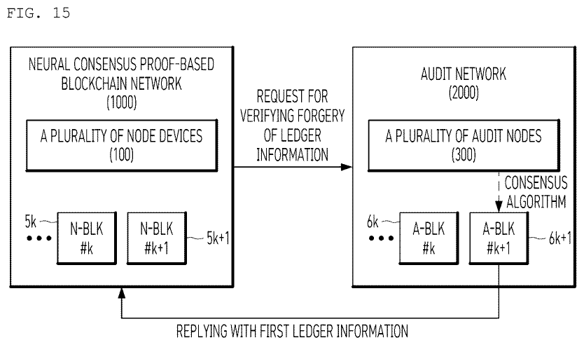

FIGS. 14 and 15 are views for explaining a method for proving and restoring the integrity of the blockchain network 1000 by using the audit network 2000.

In the present exemplary embodiment, an exemplary embodiment may be described where the forgery is verified through the audit network 2000 and the integrity of the blockchain network 1000 is restored by using the audit ledger information of the audit network 2000, when the integrity is damaged in the neural consensus proof-based blockchain network 1000 described above.

Referring to FIG. 14, in order to determine whether the integrity of the neural consensus proof-based blockchain network 1000 is damaged, each ledger information 10 of the plurality of node devices 100 composing the neural consensus proof module cluster of the neural consensus proof-based blockchain network 1000 may be extracted. Then, a plurality of extracted ledger information 10 may be compared with each other. In this case, when a discrepancy is found between a plurality of ledger information 10, the ledger information of the plurality of node devices 100 may be considered to be damaged, and a request for confirming forgery of the ledger information may be sent to the plurality of audit nodes 300 in the audit network 2000.

Meanwhile, when verifying the integrity through a typical consensus algorithm, the ledger information may be considered to be damaged when 51% consensus is not achieved for the plurality of ledger information 10, but in the present exemplary embodiment, when even a ledger information not identical with another ledger information is among the plurality of ledger information 10 (i.e., when any ledger information is different from another ledger information among the plurality of ledger information), it may be determined that the ledger information is damaged and a request for confirming forgery of the ledger information may be transmitted. This may be because when a 51% attack on the plurality of ledger information 10 is successful, it may be possible that the ledger information is damaged even when there is a consensus of more than 51%. In this case, it may be not possible to accurately determine whether the ledger information is damaged only by the consensus process for the plurality of ledger information 10. Therefore, in the present exemplary embodiment, it may be determined that the ledger information is damaged when even a ledger information not identical with another ledger information is among the plurality of ledger information 10.

When it is determined that the ledger information of the blockchain network 1000 is damaged, a request for verifying forgery of the ledger information may be transmitted to the plurality of audit nodes 300, and the plurality of audit nodes 300 may verify the forgery of the plurality of ledger information 10 in response to the verification request and may then reply with the first ledger information whose integrity is proven as the verification result of the ledger information forgery.

In this case, the plurality of audit nodes 300 may verify forgery of the plurality of ledger information 10 by comparing the plurality of ledger information 10 with its owned audit ledger information, whose integrity is proven, and may reply with the verification result of the forgery. To this end, the plurality of audit nodes 300 may be provided with the same transaction data as the transaction data provided to the blockchain network 1000 and may record the transaction data in each audit ledger information of the plurality of audit nodes 300 through the block generation process of the audit network 2000. Then, the forgery of the ledger information may be verified by comparing whether the plurality of ledger information 10 are identical with the audit ledger information.

For example, suppose that external data for electronic notarization is generated as shown in FIG. 1. In this case, the external data may be provided to the blockchain network 1000 and the plurality of audit nodes 300, respectively, and the blockchain network 1000 may update each ledger information of the plurality of node devices 1000 with the ledger information including the external data by using the neural consensus proof-based block generation process, and along with that the plurality of audit nodes 300 may update each audit ledger information of the audit nodes 300 with the audit ledger information including the external data by using their own consensus algorithm. Through this, the external data for electronic notarization may be stored in both the blockchain network 1000 and the audit network 2000, and even when the ledger information of the blockchain network 1000 is damaged by attack, the integrity of the ledger information of the blockchain network 1000 may be restored by using the audit ledger information stored in the audit network 2000. In this case, the external data may be data including an original electronic notarization document or a hash value extracted from the electronic notarization document.

As an exemplary embodiment, the plurality of audit nodes 300 may be nodes composing an audit committee, and the audit committee may be a committee that verifies and restores the integrity of audit ledger information held by the audit node 300 through a predetermined blockchain consensus algorithm.

In this case, the predetermined blockchain consensus algorithm may be an algorithm including Proof of Work (PoW), Proof of Stake (PoS), Delegate Proof of Stake (DPos), Zero-Knowledge Proofs, Practical Byzantine Fault Tolerance (PBFT), or a random consensus algorithm based on neural consensus proof, and may be a consensus algorithm that operates independently from the plurality of node devices 100.

As an exemplary embodiment, the audit network 2000 to which the plurality of audit nodes 300 belong may be a network separated from the blockchain network 1000. This may be for minimizing the likelihood that the blockchain network 1000 and the audit network 2000 are attacked together, by maintaining the audit network 2000 separate from the blockchain network 1000.

For further explanation, FIG. 15 will be referred.

Referring to FIG. 15, suppose that the blockchain network 1000 and the audit network 2000 generate up to the k-th blocks (5k, 6k) respectively. Then, suppose that there exists the ledger information not identical with another ledger information among the plurality of ledger information 10 clustered from the plurality of node devices 100.

In this case, it may be determined that the ledger information of the blockchain network 1000 is forged (or damaged), and the blockchain network 1000 may transmit a request for verifying the forgery of the ledger information to the audit network 2000.

In response to the request for verifying the forgery of the ledger information, the audit network 2000 may verify forgery of ledger information by using the method described with reference to FIG. 13. Then, the audit network 2000 may reply with the audit ledger information held by a plurality of audit nodes 300 to the blockchain network 1000 as the first ledger information whose integrity is proven.

As an exemplary embodiment, the audit network 2000 may additionally perform an integrity verification procedure with respect to the audit ledger information of the plurality of audit nodes 300, and through this, may reply with the audit ledger information, whose integrity is proven, to the blockchain network 1000 as the first ledger information. For example, the audit network 2000 may additionally perform a consensus algorithm of the audit network 2000 through the plurality of audit nodes 300 in response to the request for verifying the forgery of the ledger information of the blockchain network 1000, and accordingly, the next audit block (6k+1) may be generated. The audit ledger information of the (k+1)-th audit block (6k+1) generated in this way may be considered to be more reliable and secure, as it is information whose integrity is proven once more by the consensus algorithm of the audit network 2000.

Then, the audit network 2000 may reply with the audit ledger information of the (k+1)-th audit block (6k+1) to the blockchain network 1000 as the first ledger information whose integrity is proven, and the blockchain network 1000 may generate the (k+1)-th neural block (5k+1) by performing the neural consensus proof-based block generation process on the basis of the first ledger information. The ledger information of the (k+1)-th neural block (5k+1) generated in this way may become identical with the audit ledger information whose integrity is proven, thereby proving and restoring the integrity of the ledger information of the blockchain network 1000.

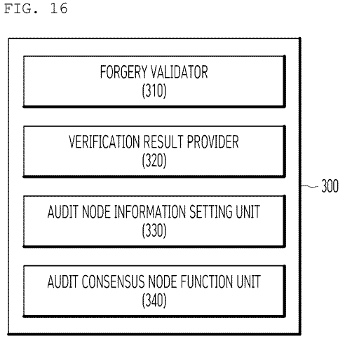

FIG. 16 is a block diagram showing a detailed configuration of an audit node 300 according to an exemplary embodiment of the present disclosure. Referring to FIG. 16, the audit node 300 may include a forgery validator 310, a verification result provider 320, an audit node information setting unit 330, and an audit consensus node function unit 340.

The forgery validator 310 may verify whether the plurality of ledger information 10 extracted from the plurality of node devices 100 is forged. In this case, it may be determined that the ledger information 10 is forged when there is a discrepancy between the plurality of ledger information 10, but the forgery validator 310 may further determine which ledger information is forged among the plurality of ledger information 10 by comparing each of a plurality of ledger information 10 with audit ledger information whose integrity is proven. For example, suppose that the first ledger information and the second ledger information among the plurality of ledger information 10 are different from each other. In this case, when the first ledger information is identical with the audit ledger information, on the basis of this, the forgery validator 310 may determine that the first ledger information is correct ledger information and the second ledger information is damaged ledger information.

The verification result provider 320 may generate a verification result based on the verification result of the forgery validator 310 and may provide the same to the blockchain network 1000. In this case, the verification result provider 320 may provide the first ledger information, whose integrity is proven, to the blockchain network 1000 in order to restore the integrity of the blockchain network 1000.

As an exemplary embodiment, the verification result provider 320 may designate the audit ledger information, whose integrity is proven by the consensus algorithm of the plurality of audit nodes 300, as the first ledger information and may reply to the blockchain network 1000. The blockchain network 1000 may restore the integrity of the ledger information of the plurality of node devices 100 by generating and distributing the next block on the basis of the provided first ledger information.

The audit node information setting unit 330 may set audit node information for registering the audit node 300. The set audit node information may include client address information of an audit network, and the audit node 300 may access the audit network 2000 through the client address information of the audit network to obtain or share block information.

The audit consensus node function unit 340 may operate a consensus algorithm for generating a block in the audit network 2000. In this case, the consensus algorithm may include Proof of Work (PoW), Proof of Stake (PoS), Delegate Proof of Stake (DPos), Zero-Knowledge Proofs, Practical Byzantine Fault Tolerance (PBFT), or a random consensus algorithm based on neural consensus proof, as described above, and by the consensus algorithm the audit ledger information may be updated in the audit network 2000.

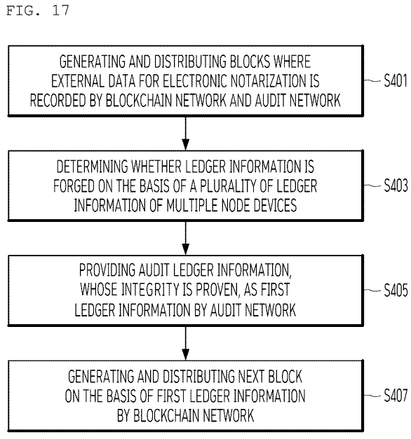

FIG. 17 is a flowchart showing a method for proving the integrity of blockchain data on the basis of anchoring technology according to an exemplary embodiment of the present disclosure. The method for auditing for forgery of the ledger information in FIG. 17 may be performed by the system 4 for proving the integrity of the blockchain data shown in FIG. 1.

First, external data for electronic notarization may be provided, and a blockchain network and an audit network may respectively generate and distribute blocks where the external data is recorded (S401).

Then, it may be determined that the plurality of ledger information are forged by clustering the plurality of ledger information from the plurality of node devices in the blockchain network and identifying a discrepancy between the plurality of clustered ledger information (S403).

In this case, when any ledger information is different from another ledger information among the plurality of ledger information, it may be determined that the ledger information agreed by the plurality of node devices is damaged.

Next, in response to determining that the ledger information is forged, the audit network may provide the audit ledger information, whose integrity is proven, to the blockchain network as the first ledger information (S405).

At this time, the audit network may once again prove the integrity of the audit ledger information held by the audit node by performing the block generation process on the basis of its own consensus algorithm through the plurality of audit nodes, and may provide the audit ledger information, whose integrity is proven in this way, to the blockchain network as the first ledger information.

Subsequently, the blockchain network may perform the neural consensus proof-based block generation process on the basis of the provided first ledger information, and thereby may generate and distribute a block where the first ledger information is recorded (S407). Accordingly, the damaged ledger information in the blockchain network may be restored.

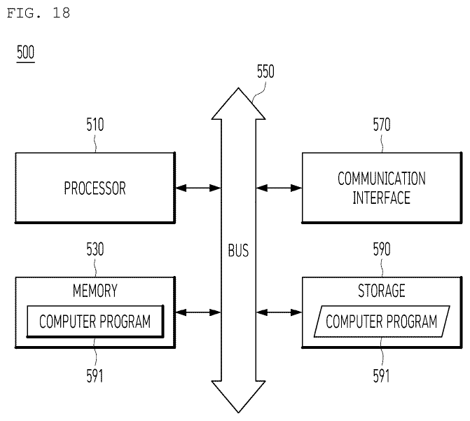

Hereinafter, an exemplary computing device 500 in which methods described in various embodiments of the present disclosure are implemented will be described with reference to FIG. 18. For example, the computing device 500 of FIG. 18 may be the node device 100 of FIG. 12 or the audit node 300 of FIG. 12.

FIG. 18 is an exemplary hardware configuration diagram illustrating the computing device 500.

As shown in FIG. 18, the computing device 500 may include one or more processors 510, a bus 550, a communication interface 570, a memory 530 for loading a computer program 591 executed by a processor 510, a storage 590 for storing computer programs 591. However, only components related to the embodiment of the present disclosure are shown in FIG. 18. Accordingly, those skilled in the art will appreciate that other general-purpose components other than those shown in FIG. 18 may be further included.

The processor 510 controls the overall operation of each component of the computing device 500. The processor 510 may be configured to include a central processing unit (CPU), micro-processor unit (MPU), micro-controller unit (MCU), and graphic processing unit (GPU), or at least one of any type of processor well known in the art. Additionally, the processor 510 may perform operations on at least one application or program to execute methods/operations according to various embodiments of the present disclosure. The computing device 500 may include one or more processors.

The memory 530 stores various data, commands and/or information. The memory 530 may load one or more programs 591 from the storage 590 to execute methods/operations according to various embodiments of the present disclosure. An example of the memory 530 may be RAM, but is not limited thereto.

The bus 550 provides communication functionality between components of computing device 500. The bus 550 may be implemented as various types of buses, such as an address bus, a data bus, and a control bus.

The communication interface 570 supports wired and wireless Internet communication of the computing device 500. The communication interface 570 may support various communication methods other than Internet communication. To this end, the communication interface 570 may be configured to include a communication module well known in the technical field of the present disclosure.

The storage 590 may store one or more computer programs 591 as non-transitory media. The storage 590 may be configured to include command memory such as read only memory (ROM), erasable programmable ROM (EPROM), electrically erasable programmable ROM (EEPROM), flash memory, a hard disk, a removable disk, or any form of computer-readable recording medium well known in the art to which the present disclosure pertains.

The computer program 591 may include one or more instructions to allow methods/operations according to various embodiments of the present disclosure to be implemented.

For example, the computer program 591 may comprises instructions for performing operations comprising: an operation for providing external data for electronic notarization, an operation for generating and distributing a block, where the external data is recorded, by a blockchain network and an audit network respectively, an operation for determining that the ledger information is forged on the basis of a plurality of ledger information after clustering the plurality of ledger information from a plurality of node devices in the blockchain network, an operation for providing audit ledger information, whose integrity is proven, to the blockchain network as a first ledger information by the audit network in the response to the determination, and an operation for generating and distributing a block, where the first ledger information is recorded, on the basis of the first ledger information by the blockchain network, wherein the blockchain network generates the block to be distributed in the blockchain network through a neural consensus proof-based block generation process.

When the computer program 591 is loaded into the memory 530, the processor 510 may perform methods/operations according to various embodiments of the present disclosure by executing the one or more instructions.

The technical idea of the present disclosure described above may be implemented as computer-readable code on a computer-readable medium. The computer-readable recording medium may be, for example, a removable recording medium (CD, DVD, Blu-ray disk, USB storage device, removable hard disk), or a fixed recording medium (ROM, RAM, computer-equipped hard disk). The computer program recorded on the computer-readable recording medium may be transmitted to another computing device through a network such as the Internet and installed on the other computing device, thereby allowing it to be used in other computing devices.

Although embodiments of the present disclosure have been described above with reference to the attached drawings, those skilled in the art can appreciate that the present disclosure can be implemented in other specific forms without changing its technical idea or essential features. Therefore, the embodiments described above should be understood in all respects as illustrative and not restrictive. The scope of protection of the present disclosure should be interpreted in accordance with the claims below, and all technical ideas within the equivalent scope should be construed as being included in the scope of the technical ideas defined by the present disclosure.

What is claimed is:

1. A method, to be performed by a computing device, for proving an integrity of blockchain data, the method comprising:
providing external data for electronic notarization;
generating and distributing a block, where the external data is recorded, by a blockchain network and an audit network respectively;
determining forgery of ledger information on the basis of a plurality of ledger information after clustering the plurality of ledger information from a plurality of node devices in the blockchain network;
providing audit ledger information, whose integrity is proven, to the blockchain network as a first ledger information by the audit network in the response to the determining forgery of ledger information; and
generating and distributing a block, where the first ledger information is recorded, on the basis of the first ledger information by the blockchain network,
wherein the blockchain network generates a block to be distributed in the blockchain network through a neural consensus proof-based block generation process.

2. The method of claim 1, wherein the determining forgery of ledger information comprises:
determining at least one of the plurality of ledger information is forged, when any ledger information among the plurality of ledger information is different from another ledger information among the plurality of ledger information.

3. The method of claim 1, wherein the providing audit ledger information comprises:
verifying integrity of the audit ledger information by using a consensus algorithm by a plurality of audit nodes in the audit network; and
providing the audit ledger information, whose integrity is verified, to the blockchain network as the first ledger information.

4. The method of claim 3, wherein the consensus algorithm of the audit node is a consensus algorithm that operates independently from the blockchain network.

5. The method of claim 3, wherein the consensus algorithm of the audit node comprises Proof of Work (PoW), Proof of Stake (PoS), Delegate Proof of Stake (dPos), Zero-Knowledge Proofs, Practical Byzantine Fault Tolerance (PBFT), or random consensus algorithms based on neural consensus proof.

6. The method of claim 1, wherein the external data comprises an electronic notarization document, or a hash value extracted from the electronic notarization document.

7. The method of claim 1, wherein the plurality of node devices perform the neural consensus proof-based block generation process according to a preset condition, and
the neural consensus proof-based block generation process comprises:
extracting an effective verification data from a new block data,
obtaining neural consensus designation information of a next block generated on the basis of a random consensus proof process according to a verification processing of the effective verification data,
selectively operating a consensus node function unit on the basis of the neural consensus designation information of the next block, and
generating another effectiveness verification data for the next block.

8. The method of claim 7, wherein the effective verification data comprises consensus process verification data corresponding to the random consensus proof process, and
the neural consensus designation information of the next block comprises nonce information for verifying participation qualification of neural consensus corresponding to the next block.

9. The method of claim 3, wherein the plurality of audit nodes belong to a network separated from the blockchain network.

10. A system for proving an integrity of blockchain data, the system comprising:
a blockchain network for electronic notarization including a plurality of node devices performing a neural consensus proof-based block generation process according to a preset condition; and
an audit network replying with audit ledger information, whose integrity is proven, as first ledger information to the blockchain network, in response to determining that ledger information of the plurality of node devices is forged,
when external data for electronic notarization is provided, the blockchain network and the audit network respectively generate and distribute a block where the external data is recorded,
the blockchain network generates a block to be distributed in the blockchain network through the neural consensus proof-based block generation process, and
the neural consensus proof-based block generation process comprises:
extracting an effective verification data from a new block data,
obtaining neural consensus designation information of a next block generated on the basis of a random consensus proof process according to a verification processing of the effective verification data,
selectively operating a consensus node function unit on the basis of the neural consensus designation information of the next block, and
generating an effectiveness verification data of the next block.
